(19) United States
(12) Patent Application Publication
(10) Pub. No.: US 2004/0062003 A1
(43) Pub. Date: Apr. 1, 2004

(54) Office desk drawer installable computer main body

(76) Inventor: Sok Whan Whang, Brea, CA (US)

Correspondence Address: Eugene Oak, Ph.D., J.D., Patent Attorney, 610 S. Van Ness Ave., Los Angeles, CA, 90005, US

(21) Appl. No.: 10/259,885

(22) Filed: Sep. 30, 2002

(51) Int. Cl. G06F 1/20

(52) U.S. Cl. 361/687

(57) ABSTRACT

A novel computer main body compact enough for installing inside of a conventional office desk is comprised of, including but not limited to, a main board assembly, CD (Compact Disk)-ROM, CD writer, DVD (Digital Video Disk ), Floppy Disk Drive (FDD), electric fan to remove accumulated heat, and ports and interfaces for other instruments and power within a cabinet. The computer assembly has a flat box shape that matches the shape a standard office desk drawer. Depth of the computer cabinet box ranges 2 to 10 cm. Horizontal length ranges from 26 to 30 cm. Vertical length ranges from 31 to 40 cm. The cabinet has cooling air windows on three side walls and hot air exhausting windows in front of the top plate of the cabinet. All access to the main computer is located at the top plate. Main power switch is located at the frontmost site of the top plate. FDD, CD-ROM, CD writer and DVD are accessible through the top plate. Ports and interfaces for power and other instruments are located at the rear part of the cabinet. A folding arm protector protects the cables for power and data communication. The dimensions of the cabinet are at least 5 cm smaller than a conventional desk drawer.

The present invention relates to a novel personal computer for installation inside of a conventional office desk drawer.

### BACKGROUND OF THE INVENTION

In most offices, a personal computer occupies a large portion of a desk. These days, monitors have become slim in order to save space. However, the main body of the computer is still bulky because of its many accessories such as a CD-ROM, a DVD and an FDD. Many business owners need a computer with a small main body, which is installable into a normal office desk without purchasing a new computer workstation.

1. Field of Invention

The present invention relates to a novel compact personal computer main body, containing a CD-ROM and a DVD and that can be installed inside of a conventional office desk.

2. Description of the Prior Art

U.S. Pat. No. 6,378,966 to Baker, et al. illustrates a device for use with a computer drawer assembly, including a safety latch. The device is comprised of a first planar portion and a second planar portion coupled to the first planar portion wherein the second planar portion retracts the safety latch during the slidable operations of the computer system. U.S. Pat. No. 6,246,576 to Sands, et al. discloses a lock and release mechanism, which includes an elongated bendable member which engages a lock tab such that when the lock tab is disengaged with the chassis, an electronics module can be moved into a variety of positions, including a service position, a closed position, and a removal position. These articles are for accessories for multi-stack computer.

U.S. Pat. No. 6,169,655 to Helot illustrates a drawer, which includes a docking platform with a docking connector. The portable computer for that drawer also includes a docking connector for mating to the drawer's docking connector. The action of closing the drawer causes the docking connectors of the drawer and the computer to mate. The drawer docking connector is electrically coupled to an expansion unit, which has ports or other interfaces for other instruments as monitor, CD-ROM, and printer, etc. U.S. Pat. No. 6,022,087 to Gilbert discloses a desk for containing computer equipment, which has at least one normal drawer and at least one false drawer front which can be moved relative to or removed from the furniture. U.S. Pat. No. 6,115, 240 to Kaneko discloses a personal computer housed desk comprising a desk body including a plurality of desk forming member. These prior arts disclose special desks and draws for computer installation.

None of these prior arts disclose a computer main body unit installable inside a standard office desk.

### SUMMARY OF THE INVENTION

It is the purpose of this invention to provide a novel computer main body compact enough for installing inside a conventional office desk drawer comprising, including but not limited to, a main board assembly, a CD-ROM, a CD writer, a DVD, an FDD, an electric fan to remove accumulated heat, and ports and interfaces for other instruments/power within a cabinet. The computer assembly has a flat box shape that matches the shape of a standard office desk drawer. Depth of the computer cabinet box ranges from 2 to 10 cm. Horizontal length ranges 26 to 30 cm. Vertical length ranges from 31 to 40 cm. The cabinet has cooling air windows on three side walls and hot air exhausting windows in front of the top plate of the cabinet. All access to the main computer is located at the top plate. Main power switch is located at the front most site of the top plate. FDD, CD-ROM, CD writer and DVD are accessible through the top plate. Ports and interfaces for power and other instruments are located at the rear part of the cabinet. The main body of the computer is connected to the other instruments through the connecting cables, which are protected by a folding arm protecting the cables from curdling and folding. The dimension of the cabinet is at least 5 cm shorter than a conventional desk drawer.

### BRIEF DESCRTIPTION OF THE DRAWINGS

FIG. 1 is a perspective view of the computer main body of this invention mounted on a fixing means in a desk drawer.

FIG. 2 is a top view of the computer main body of this invention.

FIG. 3 is a schematic drawing showing relative positon of main parts.

FIG. 4 is a rear view of the computer main body of this invention showing connecting ports.

FIG. 5 is a perspective drawing of airflow and external power supply around the computer main body of this invention.

FIG. 6 is a perspective drawing of the folding arm wire protector of this invention.

FIG. 7 is a cross sectional side view of the drawer and the folding arm wire protector.

FIG. 8 is another embodiment of a cross sectional side view of the drawer and the folding arm wire protector.

### DETAILED DESCRIPTION OF THE PREFERRED EMBODIMENTS

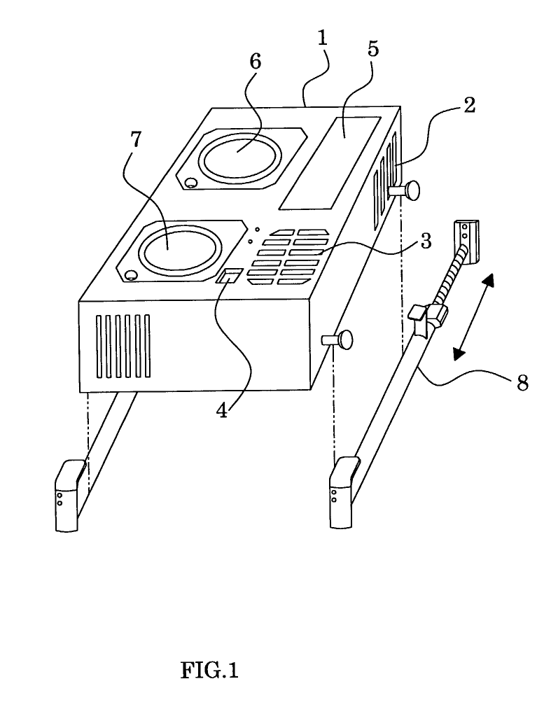

FIG. 1 is a perspective view of the computer main body of this invention. The computer main body (1) has flat box geometry to match with an office desk drawer's geometry. The cabinet has cooling air windows (2) at three sidewalls and hot air exhausting window (3) in front part of the top plate of the cabinet. All access to the main computer is located on the top plate. Main power switch (4) is located at the front most site of the top plate. FDD (5), CD-ROM (6), CD writer (7) or DVD (7) are accessible through the top plate. Depth of the computer cabinet box is in the range of 2 to 10 cm. The dimensions of the cabinet are at least 5 cm smaller than a conventional desk drawer for easy access. The main body (1) is fixed in a drawer by fixing means (8).

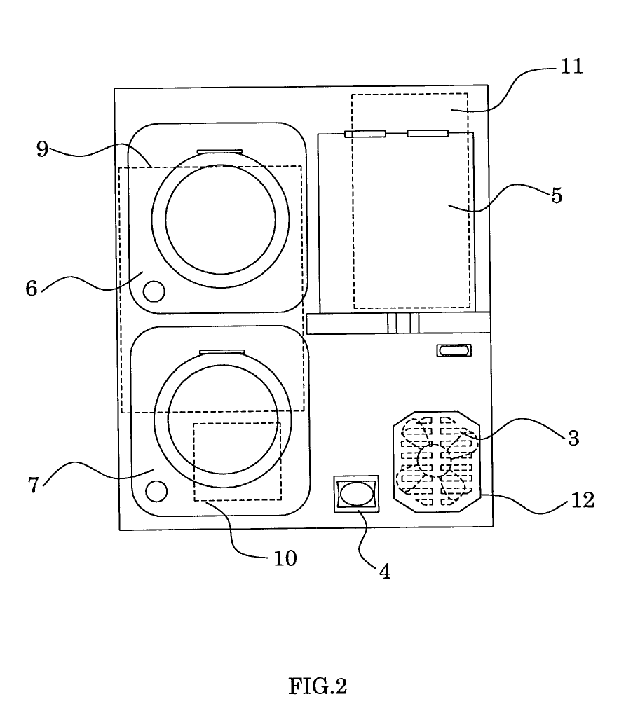

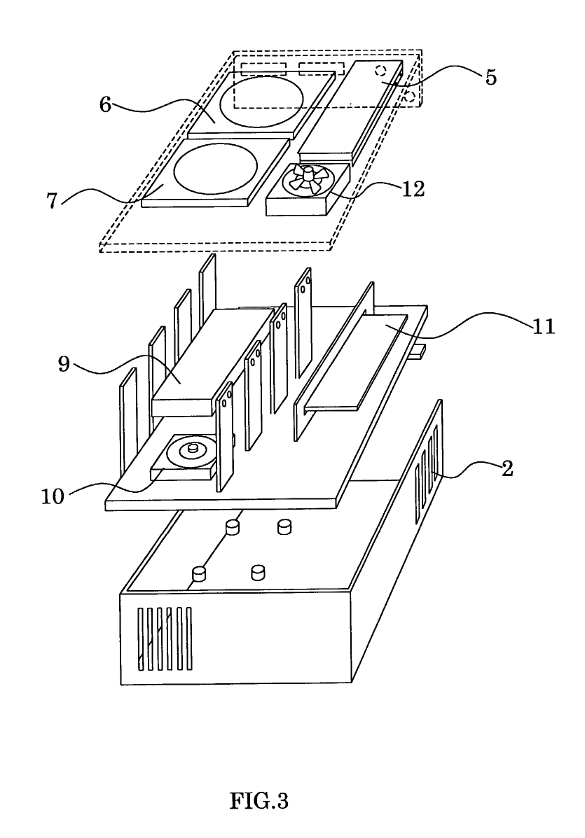

FIG. 2 is a top view of the computer main body of this invention. FIG. 3 is a schematic drawing showing relative positon of main parts. Hard Disk Drive (HDD) (9) is located beneath the CD-ROM (6) and CD writer (7). Central Processing Unit (CPU) (10) is located beneath the CD writer (7). Under the FDD (5) is located an Extension Card (11). An electric fan (12) is located just beneath the hot air exhausting window (3).

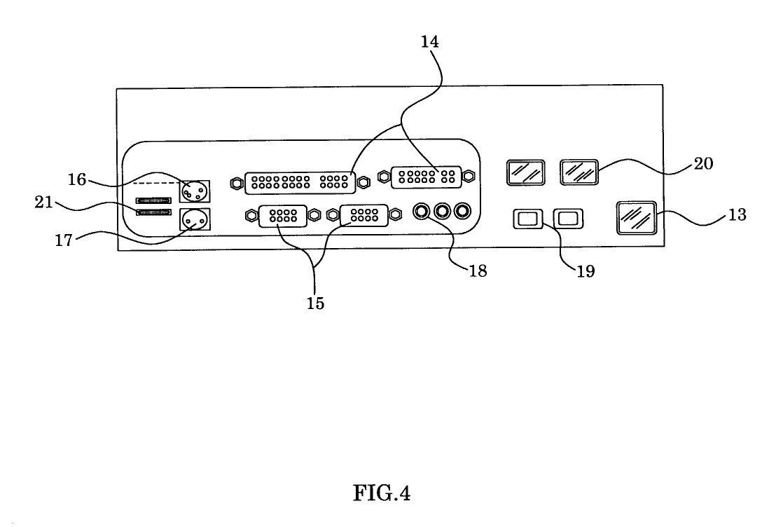

FIG. 4 is a rear view of the computer main body of this invention showing connecting ports. The rear wall has ports for a power connector (13), two parallel connectors (14) for printer and the other for other instruments, two serial connectors (15), a mouse connector (16), a keyboard connector (17), audio jacks (18), two LAN connectors (19), two modem connectors (20) and two Universal Serial Buses (USB) (21).

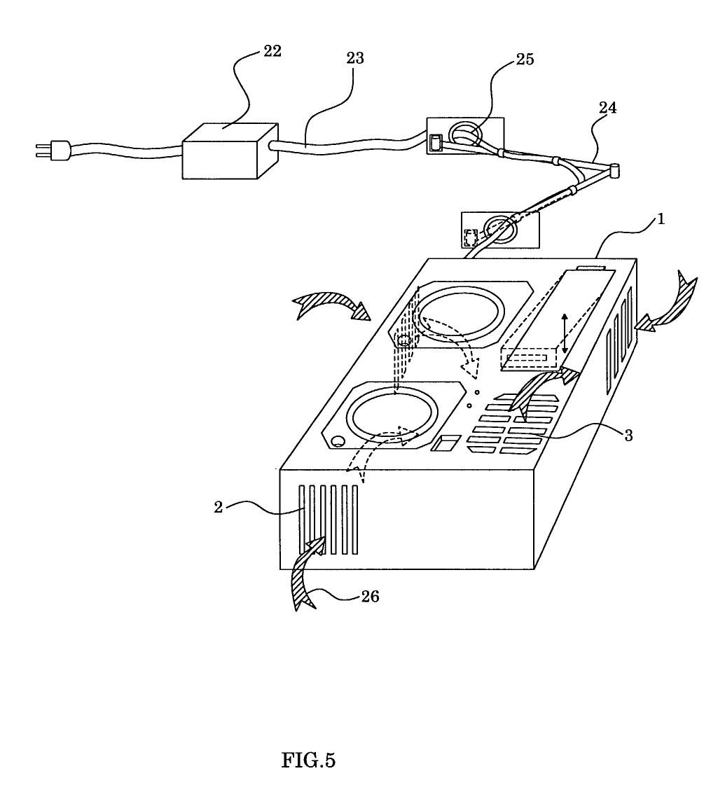

FIG. 5 is a perspective drawing of airflow and arrangement of external power supply for the computer main body of this invention. The AC/DC power supply (22) is installed outside of the main body (1). After the power is reduced down to 5-Volt and 12-Volt DC, two kind of powers are supplied to the main body through one power line bundle (23) supported by a folding arm support (24) and connecting bolts and nuts (25). Cool air (26) comes into the main body (1) through cooling air windows (2) on the side walls and comes out through hot air exhausting window (3) after they remove heat from the major parts in the main body (1).

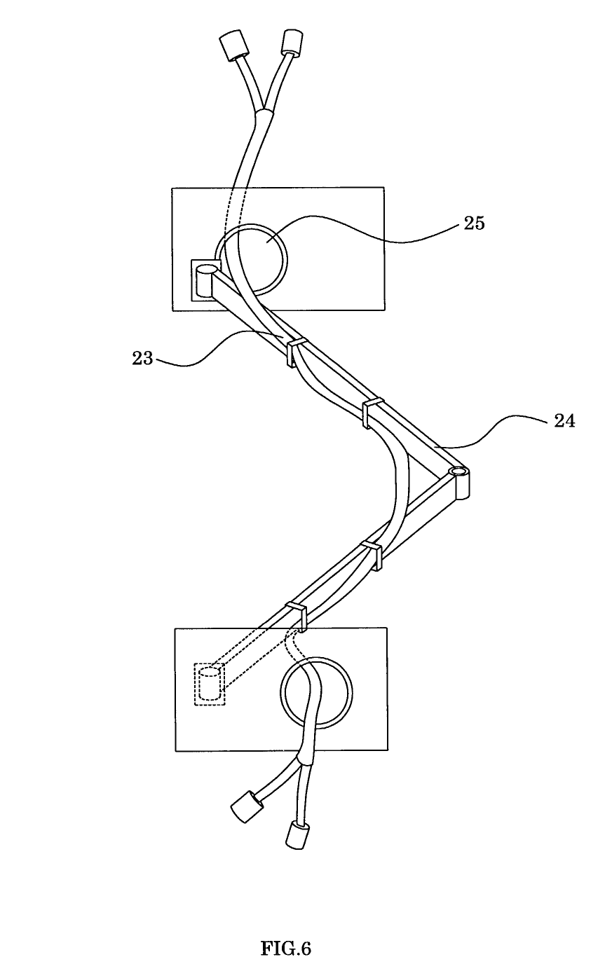

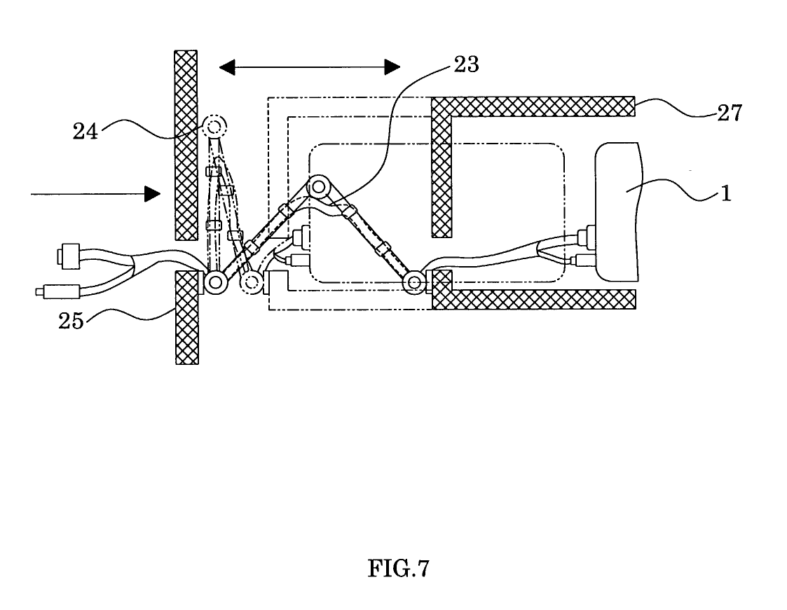

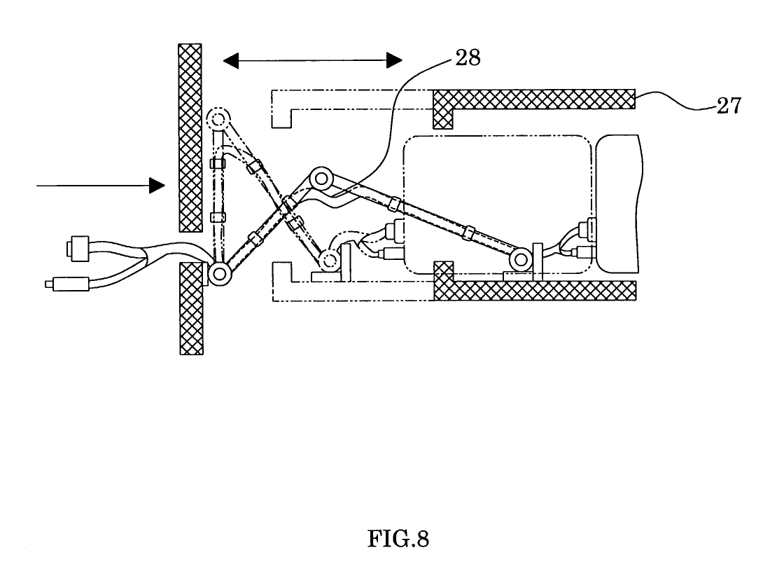

FIG. 6 is a perspective drawing of the folding arm wire support (24) of this invention. FIG. 7 is a cross sectional side view of the drawer (27) and the folding arm wire protector (24). The power line bundle (23) and the folding arm wire support (24) are stretched and retracted as the drawer (27) comes out and back into the desk. FIG. 8 is another embodiment of a cross sectional side view of the drawer and folding arm support. If the back face of the drawer (27) has clearance (28) for the folding arm wire support, the drawer (27) can be put into the desk further.

What is claimed is

1. A novel compact, flat, box shaped computer main body installable into the drawer of a standard office desk, which is comprised of a main board assembly, CD-ROM, CD writer, DVD, Floppy Disk Drive (FDD), electric fan and four air circulating windows, main power switch, and ports and interfaces for other instruments/power assembled within a cabinet.

2. The computer main body, in claim 1, is fixed to a drawer by fixing means.

3. The depth of the computer cabinet, in claim 1, ranges frm 2 to 10 cm.

4. Four of the air circulating windows, in claim 1, are located on three side walls of the cabinet for cooling air income.

5. One of the air-circulating windows, in claim 1, is located on the top face of the cabinet for removing heat accumulated.

6. The electric fan, in claim 1, is located underneath of the air-circulating window located on the top face of the cabinet.

7. The CD-ROM, in claim 1, is accessible and operable from the top face of the cabinet.

8. The CD writer, in claim 1, is accessible and operable from the top face of the cabinet.

9. The DVD, in claim 1, is accessible and operable from the top face of the cabinet.

10. The FDD, in claim 1, is accessible and operable from the top face of the cabinet.

11. The main power switch, in claim 1, is accessible and operable from the front top face of the cabinet.
